(19) United States
(12) Patent Application Publication
(10) Pub. No.: US 2021/0293617 A1
(43) Pub. Date: Sep. 23, 2021

(54) SPECTROMETER

(71) Applicant: InnoSpectra Corporation, Hsin-Chu (TW)

(72) Inventors: Fei-Peng Chang, Hsinchu County (TW); Kuo-Sheng Huang, Hsinchu County (TW); Hsi-Pin Li, Hsinchu County (TW)

(73) Assignee: InnoSpectra Corporation, Hsin-Chu (TW)

(21) Appl. No.: 17/197,036

(22) Filed: Mar. 10, 2021

(30) Foreign Application Priority Data
Mar. 17, 2020 (CN) 202010184928.5

(51) Int. Cl. G01J 3/02; G01J 3/10; G01J 3/42

(52) U.S. Cl. CPC G01J 3/0208; G01J 3/10; G01J 2003/425; G01J 2003/102; G01J 3/42

(57) ABSTRACT

A spectrometer is configured to measure a spectrum of a to-be-measured object and includes a spectrometer body and a sampling module. The spectrometer body has a light-incident port. The sampling module is disposed on the spectrometer body and includes a light source fixing base and at least one light source. The light source fixing base has at least one cup-shaped reflecting curved surface. The light source is disposed on the light source fixing base. The cup-shaped reflecting curved surface surrounds the light source. Illumination light emitted by the light source is reflected and converged by the cup-shaped reflecting curved surface and transmitted to the to-be-measured object. The to-be-measured object diffusely reflects the illumination light into to-be-measured light. The to-be-measured light enters the spectrometer body through the light-incident port and is measured by the spectrometer body. In the invention, high spectrum quality is achieved and a small volume is provided.

### CROSS-REFERENCE TO RELATED APPLICATION

This application claims the priority benefit of China application serial no. 202010184928.5, filed on Mar. 17, 2020. The entirety of the above-mentioned patent application is hereby incorporated by reference herein and made a part of this specification.

### BACKGROUND

### Technical Field

The invention relates to an optical device, and in particular, to a spectrometer.

### Description of Related Art

Generally, a sampling module of a spectrometer includes at least one bulb and a light receiving lens. The bulb emits light rays to a to-be-measured sample. After entering the to-be-measured sample, the light rays are diffusely reflected to reversely pass through the light receiving lens and finally enters the spectrometer to obtain spectrum information of the sample.

However, the light receiving efficiency of the known sampling module is poor after the light rays are diffusely reflected. Generally, the wattage of the bulbs or the number of the bulbs is increased to enhance intensity of a light source so as to improve the light receiving efficiency. But the load of a system power source and power consumption may be increased when the intensity of the light source is improved or the number of the bulbs is increased. Meanwhile, the heat energy is increased, which causes a measurement error.

In another sampling module, the intensity of light irradiated to a to-be-measured object is improved by adopting bulbs with reflecting lamp cups. But the volume of the bulbs including the reflecting lamp cups is excessively large, and a conflict between the design and volume of a reflective module thereby arises, which is not conducive to applications of a handheld spectrometer. In addition, the bulbs may not be easily arranged is a centralized manner as well. When distances between the bulbs increase, the distances from the bulbs to the plane of the to-be-measured object are increased. Although light-exit efficiency may be improved through the reflecting lamp cups, as the distances from the bulbs to the plane of the to-be-measured object increase, the optical path length is increased, the light receiving efficiency is also reduced, and the spectrum quality may further be considerably affected by stray light.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention provides a spectrometer exhibiting high spectrum quality and small volume.

An embodiment of the invention provides a spectrometer configured to measure a spectrum of a to-be-measured object. The spectrometer includes a spectrometer body and a sampling module. The spectrometer body is provided with a light-incident port. The sampling module is disposed on the spectrometer body. The sampling module includes a light source fixing base and at least one light source. The light source fixing base is provided with at least one cup-shaped reflecting curved surface. The light source is disposed on the light source fixing base, and the cup-shaped reflecting curved surface surrounds the light source. Illumination light emitted by the light source is reflected and converged by the cup-shaped reflecting curved surface and is transmitted to the to-be-measured object. The to-be-measured object diffusely reflects the illumination light into to-be-measured light. The to-be-measured light enters the spectrometer body through the light-incident port and is measured by the spectrometer body.

An embodiment of the invention provides a sampling module configured to collect a spectrum of a to-be-measured object. The sampling module includes a light source fixing base and at least one light source. The light source fixing base is provided with at least one cup-shaped reflecting curved surface. The at least one light source is disposed on the light source fixing base. The cup-shaped reflecting curved surface surrounds the light source. Illumination light emitted by the light source is reflected and converged by the cup-shaped reflecting curved surface and transmitted to the to-be-measured object. The to-be-measured object diffusely reflects the illumination light into to-be-measured light. The to-be-measured light is transmitted back to the sampling module.

An embodiment of the invention provides a spectrometer configured to measure a spectrum of a to-be-measured object. The spectrometer includes a spectrometer body and a sampling module. The spectrometer body is provided with a light-incident port. The sampling module is disposed on the spectrometer body. The sampling module includes a plurality of lenses disposed between the to-be-measured object and the light-incident port of the spectrometer body. Outside light is transmitted to the to-be-measured object to form to-be-measured light. The to-be-measured light enters the spectrometer body sequentially through the plurality of lenses and the light-incident port and is measured by the spectrometer body.

In the spectrometer according the embodiments of the invention, since the light source fixing base of the sampling module is provided with the cup-shaped reflecting curved surfaces so as to concentrate the light emitted by the light source onto the to-be-measured object, the intensity of the to-be-measured light entering the spectrometer body can be improved, which further improves the spectrum quality. In addition, since the cup-shaped reflecting curved surface is a surface of the light source fixing base, bulbs with lamp cups are not needed. In this way, costs of the bulbs used are reduced, and the volume of the sampling module is lowered as well, so that the volume of the spectrometer is decreased. In addition, since the volume of the spectrometer is small, a short optical path length is provided, and therefore, both optical efficiency and the spectrum quality are improved.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a spectrometer according an embodiment of the invention.

FIG. 2 is a front view of a portion of a sampling module of the spectrometer of FIG. 1.

FIG. 3 is a schematic diagram of optical paths of part of elements of a spectrometer according to another embodiment of the invention.

FIG. 4 and FIG. 5 respectively depict two using scenarios in which a light source fixing base in the spectrometer of FIG. 1 is detached.

FIG. 6 is a chart comparing light intensities of to-be-measured light collected in the spectrometer of FIG. 1 and in a spectrometer without a cup-shaped reflecting curved surface.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing”, “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

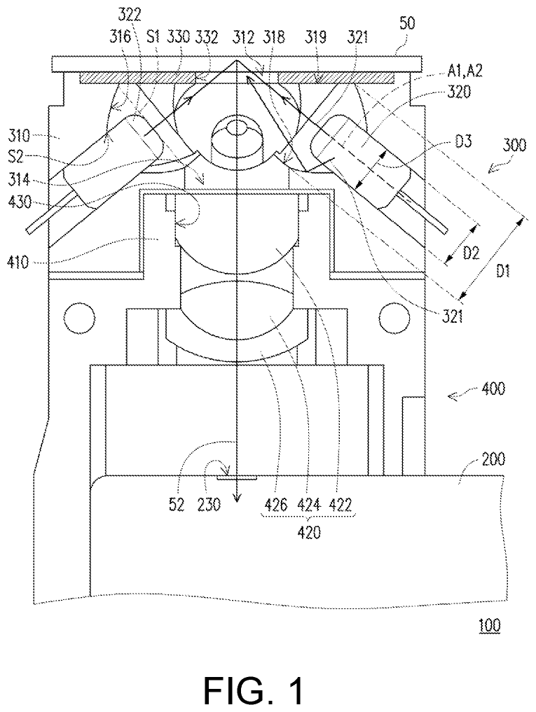

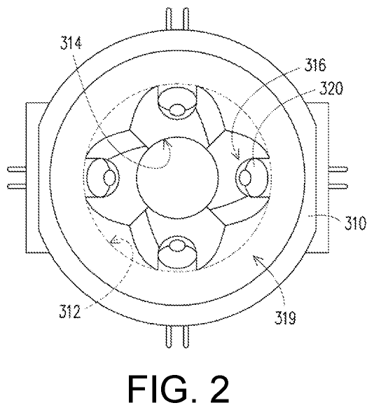

FIG. 1 is a schematic cross-sectional view of a spectrometer according tan embodiment of the invention. FIG. 2 is a front view of a portion of a sampling module of the spectrometer of FIG. 1. Referring to FIG. 1 and FIG. 2, a spectrometer 100 of the embodiment is configured to measure a spectrum of a to-be-measured object 50. The spectrometer 100 includes a spectrometer body 200 and a sampling module 300. The spectrometer body 200 is provided with a light-incident port 230. The sampling module 300 is disposed on the spectrometer body 200 to form the spectrometer 100. The sampling module 300 includes a light source fixing base 310 and at least one light source 320 (a plurality of light sources 320 are taken as an example in the embodiment). The light source fixing base 310 is provided with a first opening 312 and a second opening 314 opposite to each other and at least one cup-shaped reflecting curved surface 316 (a plurality of cup-shaped reflecting curved surfaces 316 are taken as an example in the embodiment). A number of the at least one cup-shaped reflecting curved surface 316 corresponds to that of the at least one light source 320. The light source fixing base 310 further includes an outer surface 319 around the first opening 312. The second opening 314 is located between the first opening 312 and the light-incident port 230 of the spectrometer body 200. The light sources 320 are disposed on the light source fixing base 310, and the cup-shaped reflecting curved surfaces 316 surround the light sources 320. In the embodiment, the light sources 320 are bulbs, and ends of the bulbs facing the first opening 312 may be provided with lenses 322. However, in other embodiments, the ends of the bulbs facing the first opening 312 may not be provided with lenses. In other embodiments, the light sources 320, for example, may be light emitting diodes (LEDs), and the invention is not limited thereto.

Illumination light 321 emitted by the light sources 320 are reflected and converged by the cup-shaped reflecting curved surfaces 316 and transmitted into the to-be-measured object 50 through the first opening 312. The to-be-measured object 50 diffusely reflects the illumination light into to-be-measured light 52. The to-be-measured light 52 enters the spectrometer body 200 sequentially through the first opening 312, the second opening 314, and the light-incident port 230 and are measured by the spectrometer body 200. In the embodiment, a diameter of the first opening 312, for example, is within a range of 6 mm to 20 mm.

In the embodiment, the cup-shaped reflecting curved surfaces 316 are provided with light-exit cross-sections S1. The light sources 320 are located in the light-exit cross-sections S1. The cup-shaped reflecting curved surfaces 316, for example, are parabolic surfaces and are configured to make the illumination light 321 into parallel light. The cup-shaped reflecting curved surfaces 316 are provided with converging ports S2 opposite to the light-exit cross-sections S1. The light sources 320 penetrate through the converging ports S2. Diameters D1 of the light-exit cross-sections S1 are greater than diameters D2 of the converging ports S2. In the embodiment, the diameters D1 of the light-exit cross-sections S1 are within a range of 4 mm to 9 mm. The diameters D2 of the converging ports S2 are within a range of 3 mm to 4 mm. In addition, in the embodiment, diameters D3 of the light sources 320 in directions (directions of main light rays of the illumination light) perpendicular to optical axes A1 of the light sources are less than the diameters D2 of the converging ports S2. Optical axes A2 of the cup-shaped reflecting curved surfaces 316 and the optical axes A1 of the light sources 320 are coaxial. In addition, the light source fixing base 310 is further provided with an annular extending reflecting surface 318 extending from edges of the light-exit cross-sections S1 to a direction away from the converging ports S2. In the embodiment, the diameters D3 are within a range of 2.5 mm to 3.5 mm.

In the spectrometer 100 of the embodiment, since the light source fixing base 310 of the sampling module 300 is provided with the cup-shaped reflecting curved surfaces 316 to concentrate the illumination light 321 emitted by the light sources 320 onto the to-be-measured object 50, intensity of the to-be-measured light 52 entering the spectrometer body 200 can be improved, and spectrum quality is thereby enhanced. In addition, since the cup-shaped reflecting curved surfaces 316 are a surface of the light source fixing base 310, bulbs with lamp cups are not needed. In this way, costs of the bulbs used are lowered, a volume of the sampling module 300 is decreased, so that a volume of the spectrometer 100 is reduced. In addition, since the volume of the sampling module 300 is small, an optical path length of the to-be-measured light 52 from the to-be-measured object 50 to the spectrometer body 200 is short. Therefore, both optical efficiency and the spectrum quality are improved.

In the embodiment, the optical axes A2 of the cup-shaped reflecting curved surfaces 316 obliquely pass through the first opening 312. In addition, in the embodiment, the optical axes A2 of these cup-shaped reflecting curved surfaces 316 obliquely pass through the first opening 312 and intersect outside the first opening 312. In other words, these optical axes A2 intersect inside the to-be-measured object 50 so that part of the illumination light 321 can go deep into the to-be-measured object 50. A substance inside the to-be-measured object 50 receives the illumination light to reflect the to-be-measured light 52, so that it is beneficial for the spectrometer 100 to measure a spectrum of the substance inside the to-be-measured object 50.

In the embodiment, the sampling module 300 further includes a shading sheet 330 disposed around the first opening 312 and provided with a light passing hole 332 exposing the first opening 312. An absorbance of the shading sheet 330 is greater than or equal to 1.5. The absorbance herein is an absorbance in spectroscopy and is defined as −log₁₀(T), where T is a light transmittance, namely a ratio obtained by dividing an intensity of transmission light by an intensity of incident light. The shading sheet may prevent stray light around the to-be-measured object 50 from entering the spectrometer 100 to disturb correctness of the spectrum. In the embodiment, a diameter of the light passing hole 332 may be within a range of 2 mm to 20 mm.

In the embodiment, the sampling module further includes a lens module 400 disposed between the light source fixing base 310 and the spectrometer body 200. The lens module 400 includes a lens barrel 410 and a plurality of lenses 420. These lenses 420 are disposed between the second opening 314 of the light source fixing base 310 and the light-incident port 230 of the spectrometer body 200 and are disposed in a light passing open hole 430 of the lens barrel 410. These lenses 420 include a first lens 422, a second lens 424, and a third lens 426 sequentially arranged in a direction from the first opening 312 to the second opening 314. The first lens 422 is a plano-convex lens (such as a plano-convex lens with a plane facing the first opening 312), the second lens 424 is a biconvex lens, and the third lens 426 is a concave-convex lens (such as a positive-meniscus lens with a concave surface facing the first opening 312). In the embodiment, the second lens 424 and the third lens 426 form a balsaming lens. In addition, a clear aperture of a convex surface of the first lens 422 is within a range of 6 mm to 8 mm, a clear aperture of the second lens 424 is within a range of 6 mm to 8 mm, and a clear aperture of the third lens 426 is within a range of 6 mm to 9 mm. A spacing between a plane of the first lens 422 and the to-be-measured object 50 on an optical axis is within a range of 5 mm to 10 mm. A mirror spacing between the first lens 422 and the second lens 424 on the optical axis is within a range of 0.03 mm to 2 mm. A spacing between the third lens 426 and the light-incident port 230 of the spectrometer body 200 is within a range of 1 mm to 6 mm. The first lens 422 to the third lens 426, for example, are all spherical lenses which are suitable for the to-be-measured light 52 with a wavelength ranging from 400 nanometers to 2,500 nanometers, but the invention is not limited thereto. Applications of these lenses 420 are that the large-angle to-be-measured light 52 is converged to enter the light-incident port 230 of the spectrometer body 200 so as to prevent the large-angle to-be-measured light 52 from being unable to be measured. Moreover, light receiving efficiency of the lenses 420 may be effectively improved, so that a signal-to-noise ratio is increased. The light-incident port 230, for example, is a slit, and common optical elements such as a spectroscope and a photo detector in the spectrometer or other appropriate optical elements may be arranged behind the light-incident port 230.

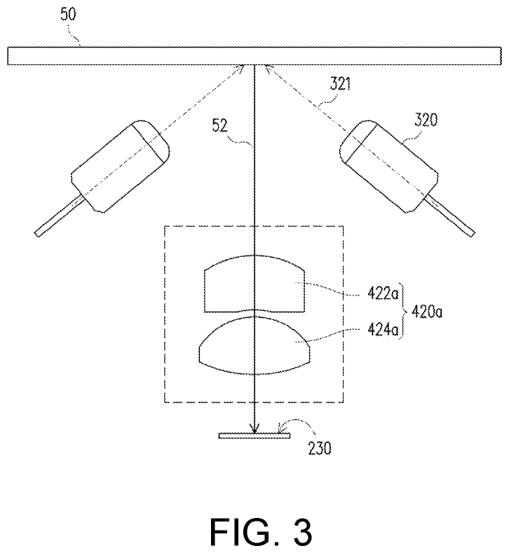

FIG. 3 is a schematic diagram of optical paths of part of elements of a spectrometer of another embodiment of the invention. Referring to FIG. 1 and FIG. 3, a plurality of lenses 420a in FIG. 3 may be configured to replace the plurality of lenses 420 in FIG. 1, so as to form a spectrometer of another embodiment. In the embodiment, these lenses 420a include a first lens 422a and a second 424a arranged sequentially. The first lens 422a is a concave-convex lens (such as a positive-meniscus lens with a convex surface facing the to-be-measured object 50), and the second lens 424a is a biconvex lens.

In the embodiment, a clear aperture of a convex surface of the first lens 422a is within a range of 4 mm to 7 mm. A clear aperture of a concave surface of the first lens 422a is within a range of 2 mm to 4 mm. A spacing between the convex surface of the first lens 422a and the to-be-measured object 50 on an optical axis is within a range of 10 mm to 15 mm. A mirror spacing between the first lens 422a and the second lens 424a on the optical axis is within a range of 0.03 mm to 2 mm. A spacing between the second lens 424a and the light-incident port 230 of the spectrometer body 200 on the optical axis is within a range of 1 mm to 5 mm. Both the first lens 422a and the second lens 424a are spherical lenses suitable for the to-be-measured light 52 with a wavelength ranging from 400 nanometers to 2,500 nanometers.

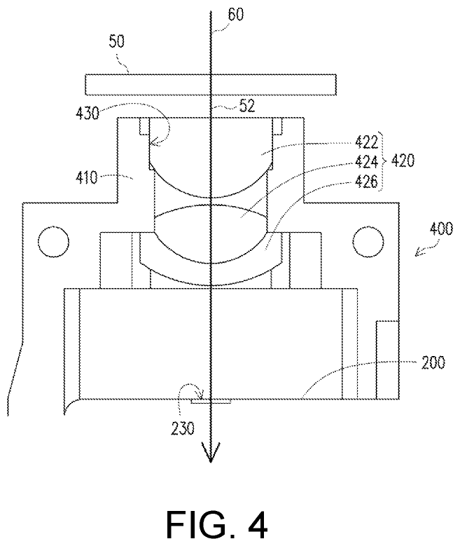

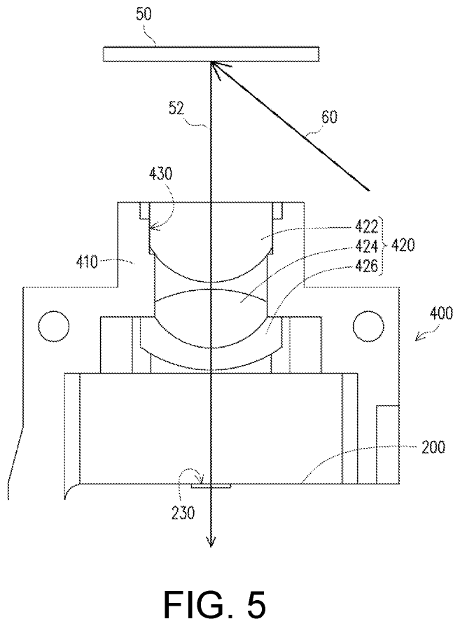

FIG. 4 and FIG. 5 respectively depict two using scenarios in which the light source fixing base in the spectrometer of FIG. 1 is detached. Referring to FIG. 1, FIG. 4, and FIG. 5, in the embodiment, the light source fixing base 310 is detachably mounted on the lens barrel 410 of the lens module 400. Therefore, when the light source fixing base 310 and the light sources 320 thereon are not needed to provide the illumination light 321, or when an outside light source with a higher light intensity needs to be adopted because the intensities of the light provided by the light source fixing base 310 and the light sources 320 thereon are insufficient, the light source fixing base 310 and the light sources 320 thereon can be detached from the lens module 400, while only the spectrometer body 200 and the lens module 400 thereon are utilized to measure the spectrum of the to-be-measured object 50. In the situation of FIG. 4, outside light 60 is transmitted to the to-be-measured object 50 to form to-be-measured light 52. In detail, the outside light 60 (such as light emitted by other light sources) penetrates the to-be-measured object 50 to form the to-be-measured light 52, and the to-be-measured light 52 enters the spectrometer body 200 through the lenses 420 and the light-incident port 230. In the scenario of FIG. 5, the to-be-measured object 50 absorbs part of a spectrum of the outside light 60 and diffusely reflects the unabsorbed spectrum to form the to-be-measured light 52, and the to-be-measured light 52 enters the spectrometer body 200 through the lenses 420 and the light-incident port 230.

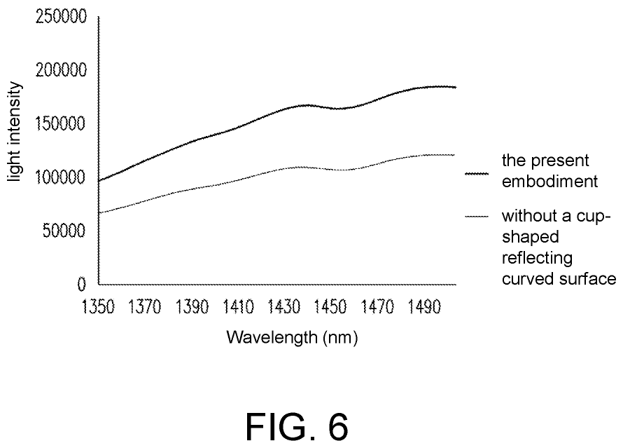

FIG. 6 is a chart comparing light intensities of to-be-measured light collected in the spectrometer of FIG. 1 and in a spectrometer without a cup-shaped reflecting curved surface. Referring to FIG. 1 and FIG. 6 first, from FIG. 6, it can be obviously seen that the light intensity of the to-be-measured light 52 received by the spectrometer 100 of FIG. 1 is about 50% higher than that of the to-be-measured light collected in the spectrometer without the cup-shaped reflecting curved surface. Therefore, the spectrometer 100 of FIG. 1 has good optical efficiency.

Based on the above, in the spectrometer according the embodiments of the invention, since the light source fixing base of the sampling module is provided with the cup-shaped reflecting curved surfaces so as to concentrate the light emitted by the light sources onto the to-be-measured object, the intensity of the to-be-measured light entering the spectrometer body can be enhanced, and that the spectrum quality is improved. In addition, since the cup-shaped reflecting curved surfaces are the surface of the light source fixing base, the bulbs with the lamp cups are not needed, so that the costs of the bulbs used are reduced, the volume of the sampling module is decreased, and the volume of the spectrometer is thereby decreased. In addition, since the volume of the spectrometer is small, the optical path length is short, and therefore, both the optical efficiency and the spectrum quality are improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A spectrometer, configured to measure a spectrum of a to-be-measured object, the spectrometer comprising a spectrometer body and a sampling module, wherein
the spectrometer body is provided with a light-incident port; and
the sampling module is disposed on the spectrometer body and comprises a light source fixing base and at least one light source, wherein
the light source fixing base is provided with at least one cup-shaped reflecting curved surface; and
the at least one light source is disposed on the light source fixing base, wherein the at least one cup-shaped reflecting curved surface surrounds the at least one light source, an illumination light emitted by the at least one light sources is reflected and converged by at least one the cup-shaped reflecting curved surface and transmitted to the to-be-measured object, the to-be-measured object diffuse reflects the illumination light into to-be-measured light, and the to-be-measured light enters the spectrometer body from the light-incident port and is measured by the spectrometer body.

2. The spectrometer according to claim 1, wherein the light source fixing base is further provided with a first opening and a second opening opposite to each other, and the second opening is located between the first opening and the light-incident port of the spectrometer body.

3. The spectrometer according to claim 1, wherein the at least one cup-shaped reflecting curved surface is provided with a light-exit cross-section, and the at least one light source is located in the light-exit cross-section.

4. The spectrometer according to claim 1, wherein at least one the cup-shaped reflecting curved surface is a parabolic surface.

5. The spectrometer according to claim 2, wherein the at least one cup-shaped reflecting curved surface is provided with a light-exit cross-section and a converging port opposite to each other, and the at least one light source penetrates through the converging port, wherein a diameter of the light-exit cross-section is greater than a diameter of the converging port.

6. The spectrometer according to claim 5, wherein a diameter of the at least one light source in a direction perpendicular to an optical axis of the at least one light source is less than the diameter of the converging port.

7. The spectrometer according to claim 5, wherein the light source fixing base is further provided with an annular extending reflecting surface extending from an edge of the light-exit cross-section to a direction away from the converging port.

8. The spectrometer according to claim 1, wherein an optical axis of the at least one cup-shaped reflecting curved surface and an optical axis of the at least one light source are coaxial.

9. The spectrometer according to claim 2, wherein the sampling module further comprises a plurality of lenses disposed between the second opening of the light source fixing base and the light-incident port of the spectrometer body.

10. The spectrometer according to claim 9, wherein the lenses comprise a first lens, a second lens, and a third lens sequentially arranged in a direction from the first opening to the second opening, the first lens is a plano-convex lens, the second lens is a biconvex lens, and the third lens is a concave-convex lens.

11. The spectrometer according to claim 9, wherein the lenses comprise a first lens and a second lens sequentially arranged in a direction from the first opening to the second opening, the first lens is a concave-convex lens, and the second lens is a biconvex lens.

12. The spectrometer according to claim 2, wherein the sampling module further comprises a shading sheet disposed around the first opening and provided with a light passing hole exposing the first opening.

13. The spectrometer according to claim 12, wherein an absorbance of the shading sheet is greater than or equal to 1.5.

14. The spectrometer according to claim 2, wherein an end of the at least one light source facing the first opening is provided with a lens.

15. The spectrometer according to claim 2, wherein an optical axis of the at least one cup-shaped reflecting curved surface obliquely passes through the first opening.

16. The spectrometer according to claim 2, wherein the at least one cup-shaped reflecting curved surface is a plurality of cup-shaped reflecting curved surfaces, and the at least one light source is a plurality of light sources, wherein optical axes of the cup-shaped reflecting curved surfaces obliquely pass through the first opening and intersect outside the first opening.

17. A sampling module, configured to collect a spectrum of a to-be-measured object, the sampling module comprising a light source fixing base and at least one light source, wherein
the light source fixing base is provided with at least one cup-shaped reflecting curved surface; and
the at least one light source is disposed on the light source fixing base, wherein the at least one cup-shaped reflecting curved surface surrounds the at least one light source, illumination light emitted by the at least one light source is reflected and converged by the at least one cup-shaped reflecting curved surface and transmitted to the to-be-measured object, and the to-be-measured object diffuse reflects the illumination light into to-be-measured light which is transmitted back to the sampling module.

18. The sampling module according to claim 17, wherein the light source fixing base is further provided with a first opening and a second opening opposite to each other.

19. The sampling module according to claim 17, wherein the at least one cup-shaped reflecting curved surface is provided with a light-exit cross-section, and the at least one light source is located in the light-exit cross-section.

20. The sampling module according to claim 17, wherein the at least one cup-shaped reflecting curved surface is a parabolic surface.

21. The sampling module according to claim 18, wherein the at least one cup-shaped reflecting curved surface is provided with a light-exit cross-section and a converging port opposite to each other, and the at least one light source penetrates through the converging port, wherein a diameter of the light-exit cross-section is greater than a diameter of the converging port.

22. The sampling module according to claim 21, wherein a diameter of the at least one light source in a direction perpendicular to an optical axis of the at least one light source is less than the diameter of the converging port.

23. The sampling module according to claim 21, wherein the light source fixing base is further provided with an annular extending reflecting surface extending from an edge of the light-exit cross-section to a direction away from the converging port.

24. The sampling module according to claim 17, wherein an optical axis of the at least one cup-shaped reflecting curved surface and an optical axis of the at least one light source are coaxial.

25. The sampling module according to claim 18, further comprising a plurality of lenses, wherein the second opening is located between the first opening and the lenses.

26. The sampling module according to claim 25, wherein the lenses comprise a first lens, a second lens, and a third lens sequentially arranged in a direction from the first opening to the second opening, the first lens is a plano-convex lens, the second lens is a biconvex lens, and the third lens is a concave-convex lens.

27. The sampling module according to claim 25, wherein the lenses comprise a first lens and a second lens sequentially arranged in a direction from the first opening to the second opening, the first lens is a concave-convex lens, and the second lens is a biconvex lens.

28. The sampling module according to claim 18, further comprising a shading sheet, disposed around the first opening and provided with a light passing hole exposing the first opening.

29. The sampling module according to claim 28, wherein an absorbance of the shading sheet is greater than or equal to 1.5.

30. The sampling module according to claim 18, wherein an end of the at least one light source facing the first opening is provided with a lens.

31. The sampling module according to claim 18, wherein an optical axis of the at least one cup-shaped reflecting curved surface obliquely passes through the first opening.

32. The sampling module according to claim 18, wherein the at least one cup-shaped reflecting curved surface is a plurality of cup-shaped reflecting curved surfaces, and the at least one light source is a plurality of light sources, wherein optical axes of the cup-shaped reflecting curved surfaces obliquely pass through the first opening and intersect outside the first opening.

33. A spectrometer, configured to measure a spectrum of a to-be-measured object, the spectrometer comprising a spectrometer body and a sampling module, wherein
the spectrometer body is provided with a light-incident port; and
the sampling module is disposed on the spectrometer body, and the sampling module comprises:
a plurality of lenses, disposed between the to-be-measured object and the light-incident port of the spectrometer body,
wherein outside light is transmitted to the to-be-measured object to form to-be-measured light, and the to-be-measured light enters the spectrometer body sequentially through the plurality of lenses and the light-incident port and is measured by the spectrometer body.

34. The spectrometer according to claim 33, wherein the lenses comprise a first lens, a second lens, and a third lens sequentially arranged in a transmitting direction of the to-be-measured light, the first lens is a plano-convex lens, the second lens is a biconvex lens, and the third lens is a concave-convex lens.

35. The spectrometer according to claim 33, wherein the lenses comprise a first lens and a second lens sequentially arranged in a transmitting direction of the to-be-measured light, the first lens is a concave-convex lens, and the second lens is a biconvex lens.
